(19) United States
(12) Patent Application Publication
(10) Pub. No.: US 2026/0059141 A1
(43) Pub. Date: Feb. 26, 2026

(54) MISSING ATTRIBUTE VALUE TRANSMISSION FOR RENDERED VIEWPORT OF A VOLUMETRIC SCENE

(71) Applicant: InterDigital CE Patent Holdings, SAS, Paris (FR)

(72) Inventors: Franck Thudor, Rennes (FR); Bertrand Chupeau, Rennes (FR); Remy Gendrot, Montgermont (FR); Francois-Louis Tariolle, Liffre (FR)

(21) Appl. No.: 19/105,655

(22) PCT Filed: Aug. 23, 2023
(86) PCT No.: PCT/EP2023/073171

§ 371 Date: Feb. 21, 2025

(30) Foreign Application Priority Data
Aug. 29, 2022 (EP) 22306274.6

(51) Int. Cl. H04N 19/597; H04N 13/15; H04N 13/161; H04N 13/178; H04N 13/282; H04N 19/70

(52) U.S. Cl. CPC H04N 19/597; H04N 13/15; H04N 13/161; H04N 13/178; H04N 13/282; H04N 19/70

(57) ABSTRACT

Methods, device and data stream are provided to generate, transmit and decode volumetric scenes. According the present principles, rendering attribute values, like color values, are transmitted to the renderer to be used as a suggested attribute value for pixels for which this attribute is missing. For example, when rendering a viewport image of a volumetric scene, some pixels may miss a color information. In such a case, the present principles provide a suggested default color. These principles apply to various rendering attributes like reflectance, transparency, material or shininess. In an embodiment, an attribute value is associated with a region of the 3D space. In another embodiment, a quality level linked to the default value helps the renderer to select a filling method.

### 1. TECHNICAL FIELD

The present principles generally relate to the domain of encoding, transmitting and rendering volumetric scenes for example when rendered on end-user devices such as mobile devices or Head-Mounted Displays (HMD) like see-through glasses. In particular, the present principles relate to attributing a color value to pixels of a viewport image of a volumetric scene when this color value cannot be retrieved from the representation of the volumetric scene. The present principles apply to various rendering attributes like reflectance, transparency, material or shininess

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

A volumetric scene is a three-dimensional (3D) scene that have been captured, for example as a multi-view plus depth image (MVD) using a collection of cameras, or, for example, modelized as a point cloud or a mesh representation. Technologies to acquire a volumetric scene are numerous and can be mixed together. The key point of a volumetric scene is that it can be rendered from points of views different from the points of views used for the capture (and/or the modeling). Source content type, compression standard, rendering device, and synthesis method may differ from one solution to another. However, in any case, when it comes to synthesize a viewport at the decoder side, a virtual camera located in 3D space of the volumetric scene is used to project the available information on a viewport image to be rendered. Depending on the completeness of the representation of the volumetric scene (which may depend on the size of the data required to encode it) and depending on the location of the virtual camera, some pixels of the viewport image may have no projected data for a given rendering attribute (also called pixel attribute). The missing pixel attribute value may be depth, color or any other rendering attribute (e.g. reflectance, transparency or shininess).

Methods to overcome the problem of missing values exist, comprising, at the encoder side inpainting parts of the representation of the volumetric scene or, at the decoder side, filtering the depth values or inpainting parts of the viewport image to be rendered. However, these methods are expansive in terms of computational resources at the decoder/renderer side. There is a lack of a format for an encoding of volumetric scenes that may direct renderers to the most appropriate solution for missing pixel values.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

Methods, device and data stream are provided to generate, transmit and decode volumetric scenes. According the present principles, rendering attribute values, like color values, are transmitted to the renderer to be used as a suggested attribute value for pixels for which this attribute is missing. For example, when rendering a viewport image of a volumetric scene, some pixels may miss a color information. In such a case, the present principles provide a suggested default color. The present principles apply to various rendering attributes like reflectance, transparency, material or shininess. In an embodiment, an attribute value is associated with a region of the 3D space. In another embodiment, a quality level linked to the default value helps the renderer to select a filling method.

The present principles relate to a method comprising encoding, in a data stream, a representation of a volumetric scene and metadata comprising a color value indicating to a renderer to set missing color values to the color value when rendering a viewport image of the volumetric scene. In an embodiment, the color value is associated with a quality level indicating to the renderer a visibility level of visual artifacts when setting missing color values to the color value. The color value may be determined as a function of color values of pixels of a multi-views image used to generate the representation of the volumetric scene. In another embodiment that may be combined to the previous embodiment, the metadata comprises at least two color values, each given color value being associated with a region of the volumetric scene indicating to the renderer to use the given color value for parts of the viewport image representing the region of the volumetric scene. The present principles apply to color value and to any other rendering attribute value, like reflectance, transparency, shininess, material, etc.

The present principles also relate to a device comprising a memory associated with a processor configured to implement the method above.

The present principles also relate to a method comprising obtaining, from a data stream, a representation of a volumetric scene and metadata comprising a color value; and, rendering a viewport image of the volumetric scene and setting missing color values to the color value.

In an embodiment, the color value is associated with a quality level indicating to the renderer a visibility level of visual artifacts when setting missing color values to the color value. The color value may be determined as a function of color values of pixels of a multi-views image used to generate the representation of the volumetric scene. In another embodiment that may be combined to the previous embodiment, the metadata comprises at least two color values, each given color value being associated with a region of the volumetric scene indicating to the renderer to use the given color value for parts of the viewport image representing the region of the volumetric scene. The present principles apply to color value and to any other rendering attribute value, like reflectance, transparency, shininess, material, etc.

The present principles also relate to a device comprising a memory associated with a processor configured to implement the method above.

The present principles also relate to a data stream comprising a representation of a volumetric scene and metadata comprising a color value indicating to a renderer to set missing color values to the color value when rendering a viewport image of the volumetric scene.

In an embodiment, the color value is associated with a quality level indicating to the renderer a visibility level of visual artifacts when setting missing color values to the color value. The color value may be determined as a function of color values of pixels of a multi-views image used to generate the representation of the volumetric scene. In another embodiment that may be combined to the previous embodiment, the metadata comprises at least two color values, each given color value being associated with a region of the volumetric scene indicating to the renderer to use the given color value for parts of the viewport image representing the region of the volumetric scene. The present principles apply to color value and to any other rendering attribute value, like reflectance, transparency, shininess, material, etc.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates a generic encoding/decoding flowchart of a volumetric scene according to the present principles;

FIG. 2 shows a viewport image of a volumetric scene in which some color information is missing;

FIG. 3 shows an example architecture of an engine which may be configured to implement the encoding and rendering present principles;

FIG. 4 shows an example of an embodiment of the syntax of a data stream encoding an volumetric scene description according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

A volumetric scene is a three-dimensional (3D) scene prepared to be rendered from points of views belonging to a region of the 3D space.

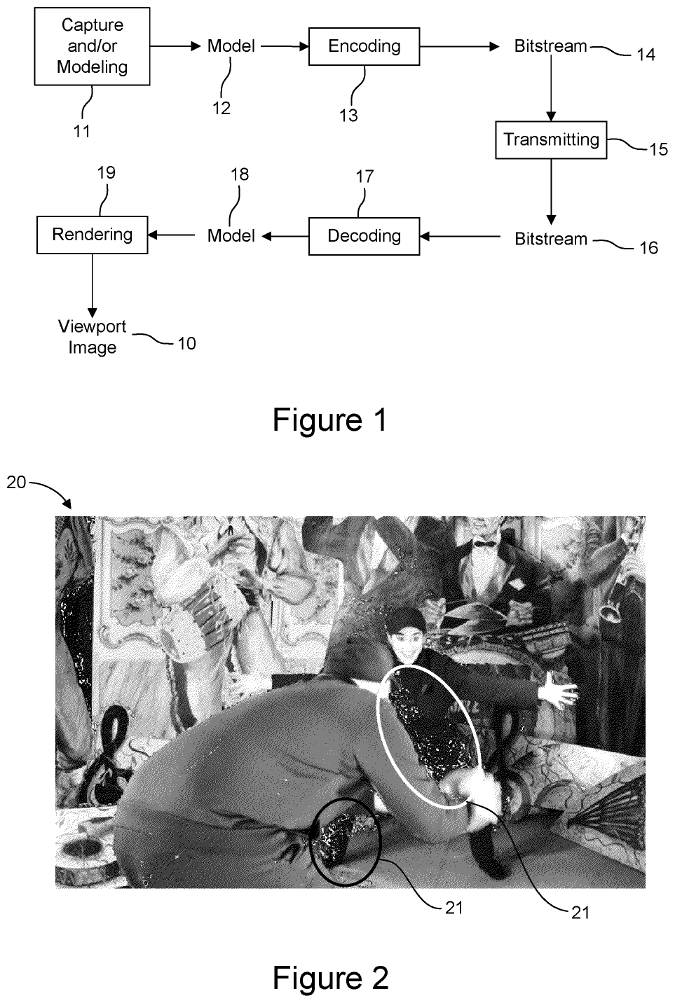

FIG. 1 illustrates a generic encoding/decoding flowchart of a volumetric scene. A 3D scene is captured at a step 11. The 3D scene may be captured, for example as a multi-view plus depth image (MVD) using a collection of cameras, or, for example, modelized as a point cloud or a mesh representation. Technologies to acquire a volumetric scene are numerous and can be mixed together to generate a model 12 of the 3D scene. At a step 13, model 12 of the 3D scene is encoded as a volumetric scene, that is a 3D scene meant to be observed from different points of view, for example, from any location within a determined region of the 3D space (or from the entire 3D space). Encoding step 13 generates a bitstream 14 which may be stored in a memory or which may be transmitted at a step 15 over a network by a transmitter. So, a bitstream 16 is received by a receiver. It is well known that bitstreams 14 and 16 may lightly differ because of transmission issues (for instance some packets may have been lost or received too late for being decoded in real time). At a step 17, received bitstream 16 is decoded to generate a model 18. Model 18 may differ from model 12 because of transmission issues and/or because of decoding problems. For example, compression method at encoding step 13 may introduce approximated values or may have deleted some information to ensure a given bit rate to bitstream 14. The decoder may also decode only a part of bitstream 16 because of memory or processing resources limitations and/or it may only decode a part of the model needed to render a viewport image 10 at a step 19 according to the rendering point of view.

Through this flowchart, the source content type (i.e. model 12), encoding and compression methods 13, and synthesis method 19 may be various. When rendering a viewport image of a volumetric scene, some pixels of the viewport might be not filled with information (for example color).

FIG. 2 shows a viewport image 20 of a volumetric scene in which some color information is missing. As shown on viewport image 20 of FIG. 2, color information is missing for pixels in areas 21. The color information of these pixels may not have been retrieved at step 19, for instance, because of the sparsity of model 12 or 18. It might occur that no ray passing from a pixel of the viewport with a given angle intercept any 3D point coming from the un-projection of any of the input views; and this is the case even before encoding, using the whole MVD input 12. Missing color information may also be due to encoding step 13. Indeed, the encoder may discard some regions of input MVD 12 or displace some points within a point cloud 12. Noise on the geometry may also be introduced during video encoding step 13, for example when the volumetric scene is encoded as patch atlases, potentially leading to displacement of points. In the example of FIG. 2, missing color is by default set to a grey value by the renderer.

Methods are proposed in the state of the art to overcome the problem of missing pixels. For example, by filtering the depth at the decoder side. In this method, after a visibility stage (i.e. testing whether a point of the decoded model is visible for a given pixel of the viewport image), some pixel of the viewport's depth map might still be unfilled. A filtering of the depth can be performed to fill a part of those pixels with depth values coming from the local neighborhood of the pixel with missing information. This method is called dilation. This solution requires processing resources at decoder side and can lead to artefacts at the contours.

Inpainting may also be performed at decoder side. In such a method, after the viewport has been synthesized from decoded data, some pixels might stay unfilled in the viewport, leading to small or larger unfilled zones. An additional step of inpainting is often performed after the synthesis. There are two general methods to perform the inpainting of those unfilled zones: 1) example-based methods, where some similar patches of pixels are searched within the rendered viewport image and adapted to the unfilled zone; 2) diffusion-based methods, where the neighborhood of the unfilled zone is used to progressively fill it. This solution has the advantage of independence with respect to the transmitted data, it only relies on a post-processing of the viewport image. However, it requires significant processing resources to be achieved by the rendering device.

Inpainting at the encoder side is also possible. As the entire captured data is available at encoder side, there is an opportunity to use these data to build a virtual view that grasps the background of the scene, forecasting that some pixels will be missing at rendering. Additional elements (patch pictures for example) are added to the encoded bitstream. This solution has two major drawbacks. First it is time consuming at encoder side because the creation of such a patch requires un-projecting/reprojecting all pixels of all source views from the MVD. Second, these additional patches do not ensure that there is no unfilled pixel at renderer stage.

According to the present principles, metadata comprising a color value indicating to the renderer to set missing color values to the color value when rendering a viewport image of the volumetric scene are encoded in data stream 14 in association with a representation of the volumetric scene. This color value is decoded from received bitstream 16 and used as a suggested default color value by the renderer to fill missing pixels of viewport image 20 at step 19. In an embodiment, the color value is transmitted encapsulated in a Supplemental Enhancement Information (SEI) message. According to the present principles, the metadata may also comprise suggested default values for pixel attributes other than color attribute, for example, transparency, material, reflectance, shininess, etc.

The following table proposes a syntax for the metadata comprising the color (or other attribute) value according to the present principles:

| | Descriptor |
|---|---|
| viewport_default_attribute_value( payloadSize ) { | |
| num_attr_minus_1 | u(4) |
| for( i = 0; i <= num_attr_minus_1 ; i++ ) { | |
| num_component_minus_1 [ i ] | u(2) |
| attribute_type_id [ i ] | u(4) |
| for( a = 0; a <= num_component_minus_1; a++ ) { | |
| value[ a ] | u(16) |
| } | |
| } | |
| } | |

In an example embodiment, the metadata are encoded in a SEI message of the volumetric video standard V3C. In this example, the SEI table in section F.2.1 General SEI message syntax of V3C would be updated accordingly:

```
else if( payloadType == 131 )
  atlas_view_enabled( payloadSize ) /* Specified in ISO/IEC 23090-12 */
else if( payloadType == 132 )
  omaf_v1_compatible( payloadSize ) /* Specified in ISO/IEC 23090-12 */
else if( payloadType == 133 )
  geometry_assistance( payloadSize ) /* Specified in ISO/IEC 23090-12 */
else if( payloadType == 134 )
  viewport_default_attribute_value( payloadSize ) /* Specified in ISO/IEC 23090-12 */
else
  reserved_sei_message( payloadSize )
```

In the example of FIG. 2, transmitting such an information, for example a suggested default color set to black, would have helped limiting the annoyance caused by the presence of grey pixels. The color value may be selected by an operator or automatically computed, for example, as an average value of the images or points of model 12, or as the minimum value of the different views or points of model 12.

In an embodiment, the 3D space is divided in regions and a color (or other attribute) value is associated with each region of the space. The color value may be determined according to color of points in this region of the 3D space. In this embodiment, the metadata associated with the volumetric scene in the data stream comprise several pairs of color (or other attribute) value and description of a region of the 3D space of the volumetric video.

In another embodiment of the present principles, an attribute value (that may be associated with a region of the 3D space) is associated with a quality level indicating to the renderer a visibility level of visual artifacts when setting missing color values to the color value. For example, a default color value may be determined according to an average color of the points of a the point cloud representing model 12. If the variance of these color data is over a given threshold, the quality value is low. If the variance of a considered region is low, the quality level is set to a high value. This is only an example. Numerous and various calculus may be used to determine a quality level. At the decoder side, considering the quality level, the renderer may use the given attribute value as a default value or select another filling method instead, for example, filtering the depth or inpainting missing parts.

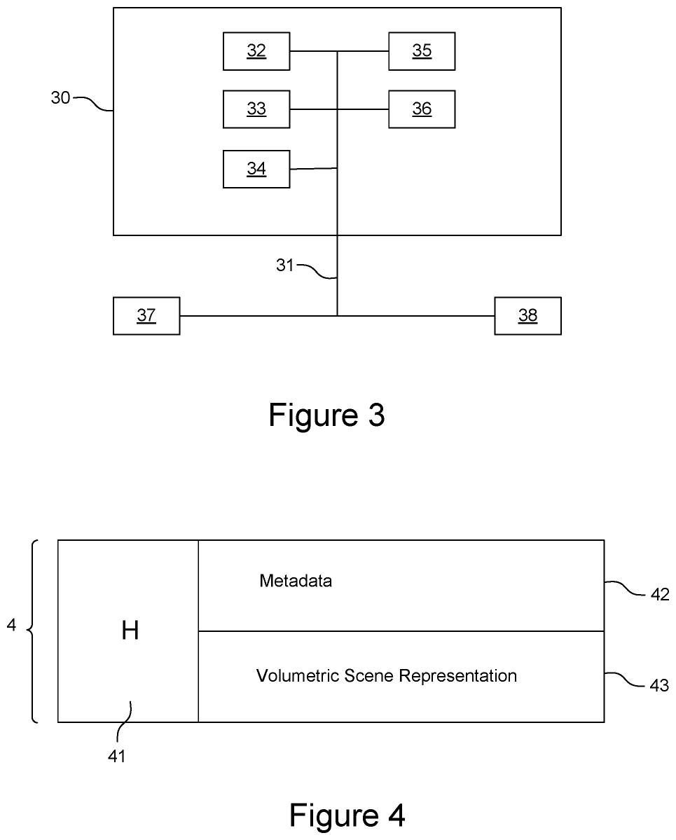

FIG. 3 shows an example architecture of an engine 30 which may be configured to implement the encoding and rendering present principles. A device according to the architecture of FIG. 3 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 2), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising:
a mobile device;
a communication device;
a game device;
a tablet (or tablet computer);
a laptop;
a still picture camera;
a video camera.

FIG. 4 shows an example of an embodiment of the syntax of a data stream encoding an volumetric scene description according to the present principles. FIG. 4 shows an example structure 4 of a volumetric scene representation. The structure consists in a container which organizes the stream in independent elements of syntax. The structure may comprise a header part 41 which is a set of data common to every element of syntax of the stream. For example, the header part comprises some of metadata about elements of syntax, describing the nature and the role of each of them. The structure also comprises a payload comprising an element of syntax 42 and an element of syntax 43. Element of syntax 42 comprises metadata representative of the media content items and comprises at least a rendering attribute value, for example a color value indicating to a renderer to set missing color values to the color value when rendering a viewport image of the volumetric scene. In an embodiment, an attribute value is associated with a region of the 3D space of the volumetric scene represented in element of syntax 43. In another embodiment, an attribute value is associated with a quality level indicating to the renderer a visibility level of visual artifacts when setting missing color values to the color value. Element of syntax 43 is a part of the payload of the data stream and comprises data encoding the representation of the volumetric scene to the present principles. Various formats may be used for this representation.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations.

Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising encoding, in a data stream, a representation of a volumetric scene and metadata comprising a color value indicating to a renderer to set missing color values to the color value when rendering a viewport image of the volumetric scene.

2. The method of claim 1, wherein the color value is associated with a quality level indicating to the renderer a visibility level of visual artifacts when setting missing color values to the color value.

3. The method of claim 1, wherein the color value is determined as a function of color values of pixels of a multi-views image used to generate the representation of the volumetric scene.

4. The method of claim 1, wherein the metadata comprises at least two color values, each given color value being associated with a region of the volumetric scene indicating to the renderer to use the given color value for parts of the viewport image representing the region of the volumetric scene.

5. The method of claim 1, wherein the metadata are encoded in a supplemental enhancement information message.

6. The method of claim 1, wherein the metadata further comprise a second value for a rendering attribute other than color, indicating to the renderer to set missing values for the attribute to the second value when rendering a viewport image of the volumetric scene.

7. A method comprising:
obtaining, from a data stream, a representation of a volumetric scene and metadata comprising a color value; and
rendering a viewport image of the volumetric scene and setting missing color values to the color value.

8. The method of claim 7, wherein the color value is associated with a quality level and wherein a method to set the missing color values is selected according to the quality level.

9. The method of claim 7, wherein the metadata comprises at least two color values, each given color value being associated with a region of the volumetric scene and wherein the given color value is used for parts of the viewport image representing the region of the volumetric scene.

10. The method of claim 7, wherein the metadata are decoded from a Supplemental Enhancement Information message.

11. The method of claim 7, wherein the metadata further comprise a second value for a rendering attribute other than color, and wherein missing values for the attribute of the viewport image are set to the second value.

12-17. (canceled)

18. A device comprising a memory associated to a processor configured to encode, in a data stream, a representation of a volumetric scene and metadata comprising a color value indicating to a renderer to set missing color values to the color value when rendering a viewport image of the volumetric scene.

19. The device of claim 18, wherein the color value is associated with a quality level indicating to the renderer a visibility level of visual artifacts when setting missing color values to the color value.

20. The device of claim 18, wherein the color value is determined as a function of color values of pixels of a multi-views image used to generate the representation of the volumetric scene.

21. The device of claim 18, wherein the metadata comprises at least two color values, each given color value being associated with a region of the volumetric scene indicating to the renderer to use the given color value for parts of the viewport image representing the region of the volumetric scene.

22. The device of claim 18, wherein the metadata are encoded in a supplemental enhancement information message.

23. The device of claim 18, wherein the metadata further comprise a second value for a rendering attribute other than color, indicating to the renderer to set missing values for the attribute to the second value when rendering a viewport image of the volumetric scene.

24. A device comprising a memory associated with a processor configured to:
obtain, from a data stream, a representation of a volumetric scene and metadata comprising a color value; and
render a viewport image of the volumetric scene and set missing color values to the color value.

25. The device of claim 24, wherein the color value is associated with a quality level and wherein a method to set the missing color values is selected according to the quality level.

26. The device of claim 24, wherein the metadata comprises at least two color values, each given color value being associated with a region of the volumetric scene and wherein the given color value is used for parts of the viewport image representing the region of the volumetric scene.

27. The device of claim 24, wherein the metadata are decoded from a Supplemental Enhancement Information message.

28. The device of claim 24, wherein the metadata further comprise a second value for a rendering attribute other than color, and wherein missing values for the attribute of the viewport image are set to the second value.
